(19) United States
(12) Patent Application Publication
(10) Pub. No.: US 2017/0011366 A1
(43) Pub. Date: Jan. 12, 2017

(54) METHOD AND SETTLEMENT PROCESSING SYSTEM FOR REINFORCING SECURITY OF SETTLEMENT

(71) Applicants: SE JIN PYO, GYEONGGI-DO (KR); MYONG CLAIRE YUN, CRESSKILL, NJ (US)

(72) Inventors: SE JIN PYO, GYEONGGI-DO (KR); MYONG CLAIRE YUN, CRESSKILL, NJ (US)

(21) Appl. No.: 14/794,823

(22) Filed: Jul. 9, 2015

(51) Int. Cl. G06Q 20/10; G06Q 20/34; G06Q 20/40

(52) U.S. Cl. CPC G06Q 20/10; G06Q 20/40; G06Q 20/34

(57) ABSTRACT

Provided is a method of reinforcing security of settlement, the method being executable on a settlement processing system connectable to an information terminal via a communication network, the method including: receiving settlement pre-approval service request information from a connectable information terminal and registering a service request by each member; and when settlement pre-approval information is received from a member whose service request is registered, via the connectable information terminal, executing a settlement approval process only for a limited designated period of time.

### TECHNICAL FIELD

One or more exemplary embodiments relate to a settlement processing system, and more particularly, to a system and method for reinforcing security of settlement via pre-authorization.

### DESCRIPTION OF THE RELATED ART

Following several information leaks repeatedly occurred over several years, the worst ever leak of information of three credit card companies was caused. The large-scale leak of personal information of the credit card companies is likely to bring secondary damages soon. For example, payments made using fake cards that are created using personal information obtained by card hacking are revealed on the Internet or by reports.

Fake credit cards are easy to create just with the credit card number and some pieces of personal information. The fake credit cards forged may be indiscriminately used without the user's consent, and damages thereby are expected to be very high. Even if the credit card password is not leaked, the leak of the term of validity and the card number of the credit cards may enable credit card payment on the Internet or use of the credit card overseas. Thus, a new method to reinforce security of settlement transactions to prevent secondary and third damages and the like due to leak of credit card information is required.

That is, as one known method to reinforce security of a settlement is to approve a settlement by verifying a true user by requesting to input the credit card number and the term of validity of the credit card or to input a password and additionally input a card verification value (CVC) under the assumption that personal information is not leaked. However, if personal financial information is completely exposed, it is not possible to prevent illegal use of personal financial information due to theft or exposure of personal financial information just by the method of verifying a true user as described above.

Also, a memory hacking technique of switching payment account information by using a new Internet banking fraud technique has appeared. The memory hacking technique changes the entire financial information for remittance by hacking a computer, and thus financial defrauders do not have to know at all personal information of a remitter such as a security card number or an authorization certificate. A method to prevent this fundamentally is also required.

### SUMMARY

One more exemplary embodiments include a method of reinforcing security of settlement, whereby damages due to exposure of financial information may be fundamentally prevented, and a settlement processing system for executing the method.

One or more exemplary embodiments include a method of reinforcing security of settlement, whereby an illegal account transfer due to memory hacking may be prevented, and a settlement processing system for executing the method.

One or more exemplary embodiments include a method of reinforcing security of settlement, in which a settlement is processed only for a limited designated period of time upon approval by a true holder of a financial account or a credit card so as to fundamentally prevent damages in terms of settlement due to exposure, theft, copying or hacking of financial information, and a settlement processing system for executing the method.

Additional aspects will be set forth in part in the description which follows and, in part, will be apparent from the description, or may be learned by practice of the presented embodiments.

According to one or more exemplary embodiments, a method of reinforcing security of settlement, the method being executable on a settlement processing system connectable to an information terminal via a communication network, wherein the method includes: receiving settlement pre-approval service request information from a connectable information terminal and registering a service request by each member; and when settlement pre-approval information is received from a member whose service request is registered, via the connectable information terminal, executing a settlement approval process only for a limited designated period of time.

In the executing of a settlement approval process, an account transfer process may be performed upon a request for an account transfer from a connectable information terminal, only for the designated period of time in response to the request for the account transfer.

The account transfer process may be performed only on account information of a recipient included in the settlement pre-approval information when performing the account transfer.

In the executing of a settlement approval process, a credit card payment process may be processed upon a request for a credit card payment from a connectable information terminal, only for the designated period of time in response to the request for the credit card payment.

In the executing of a settlement approval process, a cash withdrawal process may be performed upon a request for a cash withdrawal from a connectable information terminal, only for the designated period of time in response to the request for the cash withdrawal.

The method may further include, if settlement pre-approval information is not received from the member whose service request is registered, via the connectable information terminal, fundamentally blocking execution of a settlement approval process on a credit card or a financial account of the member.

The method may further include, when a request for processing a settlement process on the credit card or the financial account of the member is received without the settlement pre-approval information, notifying an alarming system or an external system of the reception of the request without the settlement pre-approval information.

According to one or more exemplary embodiments, a method of reinforcing security of a settlement, the method being executable on a server that is connectable to an information terminal via a communication network, wherein the method includes: receiving settlement pre-approval service request information from a connectable information terminal and registering a service request by each member; and requesting from a settlement processing system to execute a settlement approval process only for a limited designated period of time when settlement pre-approval information is received from a member whose service request is registered, via the connectable information terminal.

The requesting to execute a settlement approval process may include requesting to execute one of an account transfer process, a credit card payment process, and a cash withdrawal process only for a designated period of time.

According to one or more exemplary embodiments, a method of reinforcing security of a settlement, the method being executable on a settlement processing system that is connectable to an information terminal via a communication network, wherein the method includes: determining whether settlement pre-approval information is received from a connectable information terminal; and when the settlement pre-approval information is received, executing a settlement approval process, only for a limited designated period of time, on a financial account or a credit card of a customer who transmitted or requested to transmit the settlement pre-approval information.

In the executing of a settlement approval process, an account transfer process may be performed upon a request for an account transfer from a connectable information terminal, only for the designated period of time in response to the request for the account transfer, or a credit card payment process may be performed upon a request for a credit card payment from a connectable information terminal, only for the designated period of time in response to the request for the credit card payment, or a cash withdrawal process may be performed upon a request for a cash withdrawal from a connectable information terminal, only for the designated period of time in response to the request for the cash withdrawal.

The account transfer process may be performed only on account information of a recipient included in the settlement pre-approval information when performing the account transfer.

According to one or more exemplary embodiments, a settlement processing system that is connectable to an information terminal via a communication network, wherein the system includes: a service-requesting member management unit configured to receive service request information of a member requesting a settlement pre-approval service, from a connectable information terminal, and storing and registering the service request information; a member authorization unit configured to check whether the service-requesting member is true when settlement pre-approval information is received via the connectable information terminal; and a settlement processing requesting unit configured to request to execute a settlement approval process only for a limited designated period of time according to the settlement pre-approval information submitted by an authorized member.

The settlement processing requesting unit may request to execute an approval process of a settlement which is one of an account transfer, a credit card payment, and a cash withdrawal based on selection information about a type of settlement included in the settlement pre-approval information.

The settlement processing system may further includes a settlement processing unit configured to process a settlement according to at least one of an account transfer process, a credit card payment process, and a cash withdrawal process upon a request to execute a settlement from a connectable information terminal, wherein the settlement processing unit processes the settlement only for a predetermined period of time for which the request to execute the settlement approval process is received from the settlement processing requesting unit.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a structural diagram of a settlement processing system and elements in the periphery therearound, according to an exemplary embodiment of the inventive concept.

FIG. 2 is an exemplary structural diagram of the settlement processing system of FIG. 1.

FIG. 3 is an exemplary flow diagram of a method of reinforcing security of settlement according to an exemplary embodiment of the inventive concept.

FIG. 4 is an exemplary flow diagram of a method of reinforcing security of settlement according to another embodiment of the inventive concept.

### DETAILED DESCRIPTION

The above-described and additional aspects of the inventive concept will be more apparent from preferred exemplary embodiments described with reference to the attached drawings. The exemplary embodiments will now be described more fully such that one of ordinary skill in the art may easily understand and work the inventive concept.

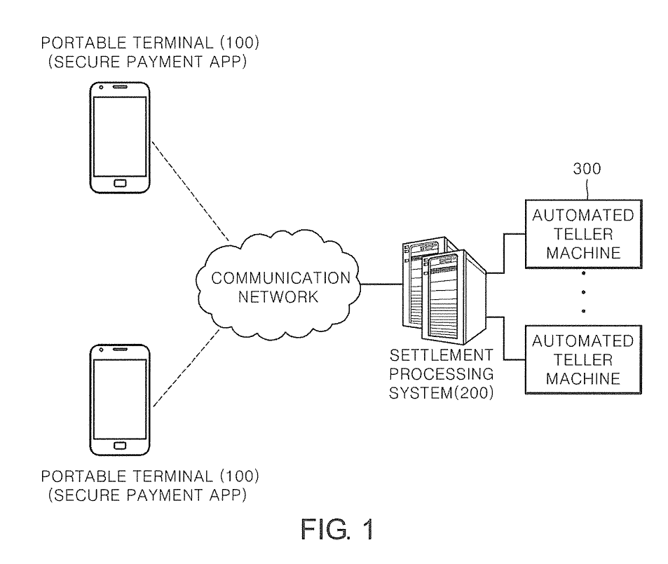

FIG. 1 is a structural diagram of a settlement processing system 200 and elements in the periphery therearound, according to an exemplary embodiment of the inventive concept. While a portable terminal 100 such as a smartphone is illustrated as an example of an information terminal connectable to the settlement processing system 200 via a communication network, not only a portable terminal but also a computer system for Internet banking or wired or wireless phones for connecting to an answering system may be used as an information terminal connectable to the settlement processing system 200.

Referring to FIG. 1, a user of the portable terminal 100 connectable to the settlement processing system 200 via a communication network may request a ‘settlement pre-approval service’ by downloading a secure payment app needed to use the service according to the inventive concept.

The ‘settlement pre-approval service’ refers to a service that allows a settlement approval procedure (process) to be carried out for a predetermined period of time only upon a request by a true user of a credit card or an account to approve a settlement just prior to the settlement. A settlement described herein is a concept including Internet banking, cash withdrawal via an automatic teller machine (ATM), an account transfer, and a credit card payment (including payment via debit cards).

In addition, the user of the portable terminal 100 may transmit settlement pre-approval information to the settlement processing system 200 via the secure payment app each time when needed (for a credit card payment, an account transfer or the like) so as to request to approve a normal settlement for a predetermined limited period of time.

The settlement processing system 200 may receive settlement pre-approval service request information from a connectable information terminal (e.g., the portable terminal 100, a terminal of a teller at a window of a financial institution, an automatic response system (ARS) or a computer terminal of a member requesting the settlement pre-approval service to register service request information (which is the same as a request for the settlement pre-approval service) of each member. When the settlement pre-approval information is received from the member whose service request is registered, the settlement processing system 200 executes a settlement approval process only for a limited designated period of time.

According to ‘execution of a settlement approval process,’ an account transfer process is performed upon a request for an account transfer from a predetermined connectable information terminal, in response to the request for the account transfer only for the designated period of time, or a credit card payment process is performed upon a request for a credit card payment from a predetermined connectable information terminal, in response to the request for the credit card payment only for the designated period of time, or a cash withdrawal process is performed upon a request for a cash withdrawal from a predetermined connectable information terminal, in response to the cash withdrawal only for the designated period of time.

The account transfer process, the credit card payment process, and the cash withdrawal process are defined herein as a series of procedures that are currently carried out for account transfer, credit card payment, or cash withdrawal of respective financial institutions, respectively (for example, confirmation of account information of a recipient, checking of a remittance amount and the balance, and checking of final remittance information). The account transfer process, the credit card payment process, and the cash withdrawal process are well-known technology in the art, and description thereof will be omitted below.

In addition, if settlement pre-approval information is not received from the member whose service request is registered, via the connectable information terminal, the settlement processing system 200 fundamentally blocks execution of a settlement approval process with respect to a credit card or a financial account held by the member. Thus, even a true account holder or a true credit card holder is not able to perform a settlement properly unless the settlement pre-approval information is received in advance, and any person who illegally obtained financial information or a credit card is not able to perform a settlement at all, thereby reinforcing security of settlement.

In addition, the settlement processing system 200 may perform an account transfer process only on account information of a recipient included in the settlement pre-approval information when processing the account transfer in order to prevent damages due to memory hacking which has recently appeared. That is, an account transfer may be limitedly executed only when an account of a recipient input for the account transfer matches an account of a recipient included in the settlement pre-approval information.

Furthermore, according to another exemplary embodiment, if a request to process a settlement regarding a credit card or a financial account held by a member is received without the settlement pre-approval information, the settlement processing system 200 may notify an alarming system (an alarming system of an ATM) or an external system (a security system) of this request without settlement pre-approval information.

According to another exemplary embodiment, the settlement processing system 200 may execute a settlement approval process each time when settlement pre-approval information is received, and may limit the number of times of approval so that a settlement approval process is executed only within the range of the limited number of times of approval.

In addition, after executing the settlement approval process, the settlement processing system 200 may transmit a result of the executing to a terminal of the member who submitted settlement pre-approval information, via a short message service (SMS) server or a push server.

The settlement processing system 200 described above may be directly established and operated by a financial institution such as a bank or a credit card company, but also, a separate settlement pre-approval service provider which is not a financial institution may establish and operate a system so as to process the rest of procedures except a portion for execution of the settlement approval process.

For reference, an ATM 300 that is not described with reference to FIG. 1 denotes a terminal that may be used in an account transfer process and that is added for convenience of description when assuming a bank as an operation subject of the settlement processing system 200.

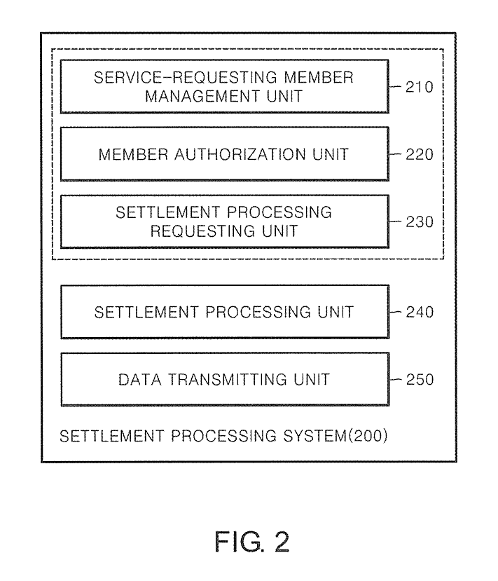

FIG. 2 is an exemplary structural diagram of the settlement processing system 200 of FIG. 1.

As illustrated in FIG. 2, the settlement processing system 200 includes a service-requesting member management unit 210 receiving service request information of a member requesting a settlement pre-approval service from a connectable information terminal (including the portable terminal 100) and storing the service request information in an internal database thereof (not shown), a member authorization unit 220 checking whether the service-requesting member is a true member upon receiving settlement pre-approval information via the connectable information terminal (including the portable terminal 100), and a settlement processing requesting unit 230 requesting the settlement processing unit 240 to execute a settlement approval process only for a limited designated period of time based on the settlement pre-approval information submitted by the authorized member.

If the settlement processing system 200 is directly established and operated by a financial institution such as a bank or a credit card company, the settlement processing system 200 may further include a settlement processing unit 240 processing a settlement according to at least one of an account transfer process, a credit card payment process, and a cash withdrawal process upon receiving a request to process the settlement via a connectable information terminal (including an ATM, a credit card terminal, a computer terminal for Internet banking, or a portable terminal). However, the settlement processing unit 240 processes a settlement only for a predetermined period of time, for which the request to execute a settlement approval process is received from the settlement processing requesting unit 230. In this case, the settlement processing unit 240 may be a separate settlement processing system operating independently of and in connection with the service-requesting member management unit 210, the member authorization unit 220, and the settlement processing requesting unit 230.

For reference, the settlement processing requesting unit 230 requests to execute an approval process for one settlement from among an account transfer, a credit card payment, and a cash withdrawal based on selection information about a type of a settlement (banking security, account security, and credit card security) included in the settlement pre-approval information.

Meanwhile, the settlement processing system 200 may further include a data transmitting unit 250 receiving a result of the executing of the settlement approval process from the settlement processing unit 240 and transmitting the result to the information terminal (the portable terminal 100) of the member who submitted the settlement pre-approval information. The data transmitting unit 250 may be implemented using an SMS server or a push server.

Hereinafter, a method of reinforcing security of settlement, executable on the settlement processing system 200 having the above-described structure will be described in detail.

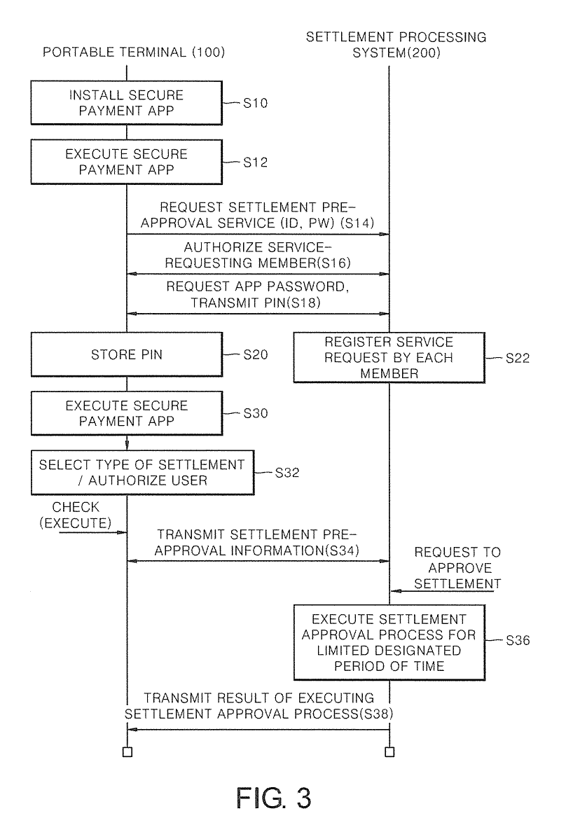

FIG. 3 is an exemplary flow diagram of a method of reinforcing security of settlement according to an exemplary embodiment of the inventive concept. Here, a bank (or a credit card company) which is a financial institution is assumed as the settlement processing system 200. Before describing exemplary embodiments, it is assumed here that an account of a customer is opened at the financial institution, and personal information needed for on-line settlement (e.g., ID, password (PW), a phone number of a portable terminal, a Personal Identification Number (PIN), etc.) are already stored in an internal database of the financial institution.

Under the assumption as above, when the customer of the financial institution wishes to request a ‘settlement pre-approval service’ according to the inventive concept in order to reinforce security of the account, first, the customer installs a secure payment app provided by the financial institution on the portable terminal 100 in step S10. The customer may also visit the financial institution and request the ‘settlement pre-approval service’ or may access an Internet page of the financial institution and request the service. It will be obvious that in all cases, authorization of the customer who is opening the account has to precede.

The customer who has installed the secure payment app (who is also a member requesting a settlement pre-approval service) executes the app in step S12. When completing inputting of an ID and a PW to an initial execution screen (logging in via an authorization certificate is also possible), the settlement pre-approval service request information is transmitted to the settlement processing system 200 in step S14.

Upon receiving the service request information, the service-requesting member management unit 210 of the settlement processing system 200 checks whether information corresponding to ID and PW stored in the internal database of the financial institution exists, and when it is determined that information match, the service-requesting member management unit 210 transmits an authorization code for authorizing a service-requesting member to the portable terminal 100 of the customer. The authorization code may be transmitted in the form of an SMS via a phone terminal registered to the settlement processing system 200 or via an ARS or a secure payment app or the like.

The service-requesting member then transmits the received authorization code to re-input the same, and the service-requesting member is authorized in step S16. The service-requesting member management unit 210 requests the service-requesting member to input a password for the app, and when the service-requesting member inputs the app password in response to the request, the service-requesting member management unit 210 generates a PIN and transmits the same to the portable terminal 100 in step S18 so that the PIN provided by the settlement processing system 200 is stored in the portable terminal 100 in step S20 and information related to the member who is requesting the settlement pre-approval service (e.g., app password, issued PIN information, etc.) is stored and registered in the settlement processing system 200 by the service-requesting member management unit 210 in step S22.

As described above, the customer of the financial institution may request the ‘settlement pre-approval service’ by installing the secure payment app on the portable terminal 100.

When the settlement pre-approval service is requested as described above, a settlement is not approved unless settlement pre-approval information which will be described later is received. Thus, when a settlement is needed to be executed, the customer who has requested the ‘settlement pre-approval service’ may execute the secure payment app in step S30 and then select a type of settlement and conduct a user authorization procedure in step S32. A type of settlement may be one of banking security, account security, and credit card security, and a true user may be authorized based on whether the app password matches (or also by using ID/PW or an authorization certificate). For reference, if account security is selected, in order to prevent damages by memory hacking, an account of a recipient needed for an account transfer may be additionally input.

After the type of settlement is selected and user authorization is performed, when a confirmation or execution command is input, the secure payment app installed on the portable terminal 100 is connected to the member authorization unit 220 of the settlement processing system 200 to request a server value (randomly generated). Then when the member authorization unit 220 returns the server value, the secure payment app transmits the settlement pre-approval information which is obtained by encoding the server value, the PIN information, the app password, the settlement type selection information, a service parameter (optional) or the like to the settlement processing system 200 in step S34. The settlement pre-approval information may be encoded by using one of well-known encoding techniques. For example, the secure payment app may generate a random seed key to encode the settlement pre-approval information, and may encode the seed key to a public key and transmit the same to the settlement processing system 200. Alternatively, requesting and returning of the server value may be performed in step S30 of executing the secure payment app, and retuning of the server value to the portable terminal 100 may be performed via a push server.

The member authorization unit 220 of the settlement processing system 200 that has received the encoded settlement pre-approval information decodes the settlement pre-approval information and checks the server value, the PIN information, and the app password to check whether the service-requesting member is true. If the stored information and the received information do not match, the member authorization unit 220 transmits an error message, and if the stored information and the received information match, the member authorization unit 220 transmits to the portable terminal 100 a message notifying that the settlement pre-approval information is properly received. Then the member authorization unit 220 transmits the settlement pre-approval information received from the authorized service-requesting member to the settlement processing requesting unit 230.

Then the settlement processing requesting unit 230 requests the settlement processing unit 240 to execute a settlement approval process only for a limited designated period of time based on the settlement pre-approval information submitted by the authorized member.

The user who has normally submitted the settlement pre-approval information via the secure payment app, that is, the member who has requested the settlement pre-approval service, conducts Internet banking at home or uses a credit card at shops, or conducts an account transfer at an ATM according to the type of settlement that the user has selected in step S32.

For example, when banking security is selected in operation S32 and Internet banking is performed at home, a request for approving a settlement according to the Internet banking is transmitted to the settlement processing unit 240 of the settlement processing system 200. The settlement processing unit 240 checks whether the settlement approval request is received within a limited period of time from a point of time when the settlement pre-approval information is received; when the request is received after the designated period time has passed, the settlement processing unit 240 notifies the unprocessable state; and when the request is received within an designated period of time, the settlement processing unit 240 executes a normal settlement approval process in step S36 to process a settlement such as an account inquiry or an account transfer. Then the settlement processing unit 240 transmits a result of executing the settlement approval process to the portable terminal 100 via the data transmitting unit 250 in step S38.

According to circumstances, upon the request for settlement approval, the settlement processing unit 240 may reinforce a settlement security procedure via a procedure of re-confirming a settlement with the member requesting the settlement pre-approval service via at least one of an SMS, an ARS, and the secure payment app.

Although Internet banking is described as an example above, when credit card security is selected in step S32 and the member who has requested the settlement pre-approval service requests a credit card payment via a connectable card terminal, the settlement processing unit 240 may perform a credit card payment process in response to the request for the credit card payment only for the designated period of time.

When account security is selected in step S32 and a request for an account transfer is received from a connectable ATM, the settlement processing unit 240 may perform an account transfer process in response to the request for the account transfer only for the designated period of time.

Furthermore, when account security is selected in step S32, in order to prevent memory hacking, the customer who has requested the service is requested to additionally input account information of a recipient. The account information of the recipient input in response to the request is included in settlement pre-approval information and transmitted to the settlement processing system 200. Then, when there is a request for processing an account transfer, the settlement processing unit 240 performs an account transfer process only for the designated period of time in response to the request for the account transfer, and only when the account information of the recipient included in the settlement pre-approval information is the same as the account of the recipient that is input when the request for the account transfer is requested.

As described above, a settlement is processed for a limited period of time only upon pre-approval by a true holder of a financial account or a credit card, thereby preventing illegal account transfer by memory hacking and illegal withdrawal of cash (cash advance), for example, by kidnapping a person and stealing a credit card of the person.

Moreover, even if credit card information or account information is leaked, a settlement is processed only upon pre-approval by a true holder of an account or a credit card for a limited period of time. Thus, damages due to exposure of financial information may be fundamentally prevented.

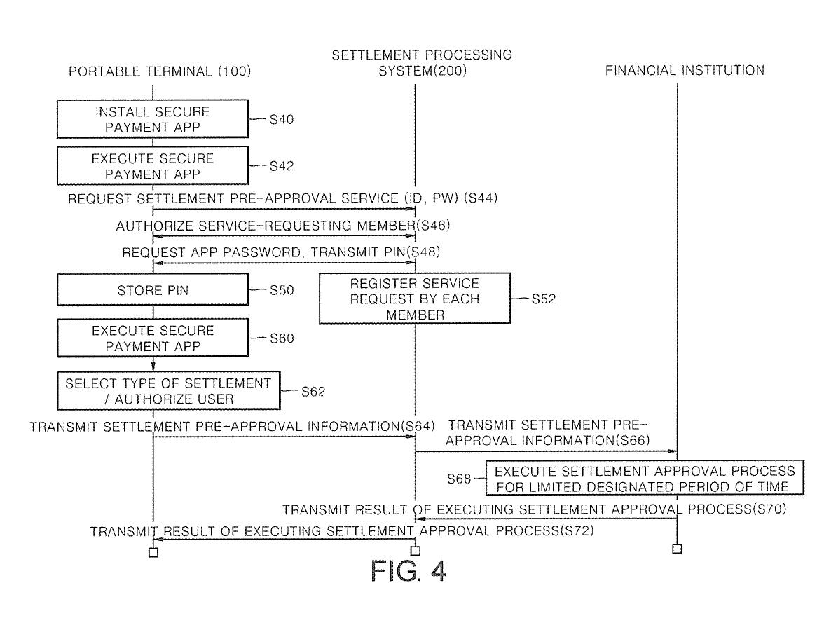

FIG. 4 is a flowchart of a method of reinforcing security of settlement according to another embodiment of the inventive concept. Here, a method of reinforcing security of settlement in a system, in which a settlement processing unit is separate from the settlement processing system 200, is illustrated. In this case, the settlement processing system 200 corresponds to a settlement pre-approval service provider, and strictly speaking, an external settlement processing system corresponds to a settlement processing unit.

Steps S40 to S64 of FIG. 4 are the same as steps S10 to S34 described with reference to FIG. 3, respectively, and thus detailed description thereof will be omitted.

In step S64 of FIG. 4, the settlement processing requesting unit 230 of the settlement processing system 200 which has received settlement pre-approval information transmits the settlement pre-approval information to the external settlement processing system which corresponds to a settlement processing unit in step S66.

Then the external settlement processing system checks whether a request for approving a settlement is received from a connectable information terminal within a limited period of time from when the settlement pre-approval information is received, and when the settlement pre-approval information is received after the designated period of time has passed, the external settlement processing system notifies the unprocessable state, and when the settlement pre-approval information is received within the designated period of time, the external settlement processing system executes a normal settlement approval process in step S68.

The settlement approval process refers to performing an account transfer process upon a request for an account transfer from a predetermined connectable information terminal, only for the designated period of time in response to the request for the account transfer, or performing a credit card payment process upon a request for a credit card payment from a predetermined connectable information terminal, only for the designated period of time in response to the request for the credit card payment, and performing a cash withdrawal process upon a request for a cash withdrawal from a predetermined connectable information terminal, only for the designated period of time in response to the request for the cash withdrawal.

When execution of the settlement approval process is completed, the external settlement processing system transmits a result of executing the settlement approval process to the settlement processing system 200 in step S70 so that the settlement processing system 200 may transmit again the result of executing the settlement approval process to the portable terminal 100 via the data transmitting unit 250.

As a settlement is processed for a limited period of time only upon pre-approval by a true holder of an account or a credit card also in the above-described modified embodiment, damages due to leak of financial information may be fundamentally prevented, and damages due to illegal account transfer by memory hacking may be prevented by using the method as described with reference to FIG. 3.

According to the one or more exemplary embodiments, even if credit card information or account information is exposed, a settlement is performed for a limited period of time only upon pre-approval by a true account holder or a true credit card holder. Thus, damages due to exposure of financial information may be fundamentally prevented.

In addition, as a settlement is processed for a limited period of time only upon pre-approval by a true account holder or a true credit card holder, illegal account transfer by memory hacking may be prevented, and illegal withdrawal of cash (cash advance), for example, by kidnapping a person and stealing a credit card of the person may also be prevented.

That is, according to the one or more exemplary embodiments, any damages in terms of settlement due to exposure, theft, copying, hacking, or capture of financial information may be fundamentally prevented by allowing a settlement process for a limited period of time only upon approval by a true customer of the settlement.

While the inventive concept has been particularly shown and described with reference to exemplary embodiments thereof, the above description describes preferred embodiments of the inventive concept for illustrative purposes only, and the inventive concept may be modified, adapted or substituted by one of ordinary skill in the art in various manners within the spirit and scope of the inventive concept. Therefore, the scope of the inventive concept is defined by the appended claims, and all differences within the scope will be construed as being included in the inventive concept.

What is claimed is:

1. A method of reinforcing security of settlement, the method being executable on a settlement processing system connectable to an information terminal via a communication network, the method comprising:
receiving settlement pre-approval service request information from a connectable information terminal and registering a service request by each member; and
when settlement pre-approval information is received from a member whose service request is registered, via the connectable information terminal, executing a settlement approval process only for a limited designated period of time.

2. The method of claim 1, wherein in the executing of a settlement approval process, an account transfer process is performed upon a request for an account transfer from a connectable information terminal, only for the designated period of time in response to the request for the account transfer.

3. The method of claim 2, wherein the account transfer process is performed only on account information of a recipient included in the settlement pre-approval information when performing the account transfer.

4. The method of claim 1, wherein in the executing of a settlement approval process, a credit card payment process is processed upon a request for a credit card payment from a connectable information terminal, only for the designated period of time in response to the request for the credit card payment.

5. The method of claim 1, wherein in the executing of a settlement approval process, a cash withdrawal process is performed upon a request for a cash withdrawal from a connectable information terminal, only for the designated period of time in response to the request for the cash withdrawal.

6. The method of claim 1, further comprising:
if settlement pre-approval information is not received from the member whose service request is registered, via the connectable information terminal, fundamentally blocking execution of a settlement approval process on a credit card or a financial account of the member.

7. The method of claim 6, further comprising:
when a request for processing a settlement process on the credit card or the financial account of the member is received without the settlement pre-approval information, notifying an alarming system or an external system of the reception of the request without the settlement pre-approval information.

8. The method of claim 1, wherein the executing of a settlement approval process is performed each time when the settlement pre-approval information is received.

9. The method of claim 1, further comprising:
after the executing a settlement approval process, transmitting or requesting to transmit a result of the executing the settlement approval process to the information terminal of the member who has submitted the settlement pre-approval information.

10. A method of reinforcing security of a settlement, the method being executable on a server that is connectable to an information terminal via a communication network, the method comprising:
receiving settlement pre-approval service request information from a connectable information terminal and registering a service request by each member; and
requesting from a settlement processing system to execute a settlement approval process only for a limited designated period of time when settlement pre-approval information is received from a member whose service request is registered, via the connectable information terminal.

11. The method of claim 10, wherein the requesting to execute a settlement approval process comprises requesting to execute one of an account transfer process, a credit card payment process, and a cash withdrawal process only for a designated period of time.

12. A method of reinforcing security of a settlement, the method being executable on a settlement processing system that is connectable to an information terminal via a communication network, the method comprising:
determining whether settlement pre-approval information is received from a connectable information terminal; and
when the settlement pre-approval information is received, executing a settlement approval process, only for a limited designated period of time, on a financial account or a credit card of a customer who transmitted or requested to transmit the settlement pre-approval information.

13. The method of claim 12, wherein in the executing of a settlement approval process,
an account transfer process is performed upon a request for an account transfer from a connectable information terminal, only for the designated period of time in response to the request for the account transfer, or
a credit card payment process is performed upon a request for a credit card payment from a connectable information terminal, only for the designated period of time in response to the request for the credit card payment, or
a cash withdrawal process is performed upon a request for a cash withdrawal from a connectable information terminal, only for the designated period of time in response to the request for the cash withdrawal.

14. The method of claim 13, wherein the account transfer process is performed only on account information of a recipient included in the settlement pre-approval information when performing the account transfer.

15. A settlement processing system that is connectable to an information terminal via a communication network, the system comprising:
a service-requesting member management unit configured to receive service request information of a member requesting a settlement pre-approval service, from a connectable information terminal, and storing and registering the service request information;
a member authorization unit configured to check whether the service-requesting member is true when settlement pre-approval information is received via the connectable information terminal; and
a settlement processing requesting unit configured to request to execute a settlement approval process only for a limited designated period of time according to the settlement pre-approval information submitted by an authorized member.

16. The settlement processing system of claim 15, wherein the settlement processing requesting unit requests to execute an approval process of a settlement which is one of an account transfer, a credit card payment, and a cash withdrawal based on selection information about a type of settlement included in the settlement pre-approval information.

17. The settlement processing system of claim 15, further comprising:
a settlement processing unit configured to process a settlement according to at least one of an account transfer process, a credit card payment process, and a cash withdrawal process upon a request to execute a settlement from a connectable information terminal,
wherein the settlement processing unit processes the settlement only for a predetermined period of time for which the request to execute the settlement approval process is received from the settlement processing requesting unit.

18. The settlement processing system of claim 15, further comprising:
a data transmitting unit configured to receive a result of executing the settlement approval process from the settlement processing unit and transmit the result to a terminal of the member who submitted the settlement pre-approval information.
